(19) United States
(12) Patent Application Publication
(10) Pub. No.: US 2020/0189978 A1
(43) Pub. Date: Jun. 18, 2020

(54) REFRACTORY ARTICLE, COMPOSITION FOR COATING REFRACTORY ARTICLE, AND METHOD OF MANUFACTURING THE REFRACTORY ARTICLE

(71) Applicant: CORNING INCORPORATED, CORNING, NY (US)

(72) Inventors: Myeong-jin Cho, Yongin-si (KR); Hong-goo Choi, Cheoan-si (KR); Jae-ho Lee, Hwaseong-si (KR); Yong-won Lee, Cheoan-si (KR)

(21) Appl. No.: 16/611,138

(22) PCT Filed: May 14, 2018
(86) PCT No.: PCT/US2018/032490

§ 371 Date: Nov. 5, 2019

(30) Foreign Application Priority Data
May 12, 2017 (KR) 10-2017-0059563

(51) Int. Cl. C04B 35/14; C03C 17/23; C03B 5/43

(52) U.S. Cl. CPC C04B 35/14; C03C 17/23; C04B 2235/3217; C04B 2235/3244; C04B 2235/3208; C03B 5/43

(57) ABSTRACT

A refractory article is described, the refractory article including a refractory body and a refractory coating layer deposited on a surface thereof, wherein the refractory coating layer includes silica, alumina, boron oxide, and calcium oxide. The refractory article may be at least one of a melting vessel, a clarifying vessel and a molding apparatus. A composition for coating a refractory article and a method of manufacturing the refractory article are also disclosed.

This application claims the benefit of priority of Korean Patent Application Serial No. 10-2017-59563 filed on May 16, 2017 the contents of which are relied upon and incorporated herein by reference in their entirety as if fully set for below.

### TECHNICAL FIELD

The disclosure relates to a refractory article, a composition for coating a refractory article, and a method of manufacturing a refractory article, and more particularly, a refractory article, a composition for coating a refractory article, and a method of manufacturing a refractory article capable of preventing or reducing impurities contained in a material treated during processes using the refractory article.

### BACKGROUND

Articles for processing materials at high temperature, particularly molten materials such as molten glass, are often formed using refractory materials. Such refractory articles may, over the course of time, shed particles (e.g., refractory grains), which, depending on the solubility of the shed particles in the molten material, and compatibility therewith, result in contamination of the material being processed. However, since FZ refractory materials typically exhibit a relatively low solubility with respect to the glass melt, if particles of the FZ refractory material are shed by the refractory article into the glass melt, these shed particles contained in the glass melt may not be completely melted and may remain in the glass melt. These unmelted particles may cause defects in various glass products produced from the glass melt.

### SUMMARY

As described herein, a refractory article capable of reducing, such as preventing, particles of the refractory article from being shed therefrom and becoming entrained as a contaminant into a material treated with or in the article, such as molten glass, is disclosed.

As disclosed herein, a composition for coating a refractory article is also described, wherein the coated refractory article is capable of reducing, such as preventing, particles of the refractory article from being shed therefrom and becoming entrained as a contaminant into a material, such as molten glass, treated with or in the article.

As described herein, methods of manufacturing a refractory article capable of reducing, such as preventing, particles of the refractory article from being shed therefrom and becoming entrained as a contaminant into a material, such as molten glass treated with or in the article are disclosed.

According to embodiments of the disclosure, a refractory article is disclosed, the refractory article including a refractory body and a refractory coating layer on a surface of the refractory body, wherein the refractory coating layer may include, on an oxide basis, SiO₂, Al₂O₃, B₂O₃, and CaO. In some embodiments, the refractory article may be, for example, a melting vessel, or any portion thereof, used in the manufacture of glass, for example in the manufacture of glass sheets. In some embodiments, the refractory article may be a conduit (e.g., tube or pipe), or any portion thereof, configured to convey molten glass in a glass manufacturing process. In some embodiments, the refractory article may be a molding apparatus. In some embodiments, the refractory article may be a refractory brick, or any article formed by one or more refractory bricks, although in further embodiments, the refractory article may be any refractory article that may be exposed to a molten material, such as molten glass, at high temperature, for example and not limitation, a temperature equal to or greater than about 800° C., equal to or greater than 900° C., equal to or greater than about 1000° C., equal to or greater than about 1200° C., for example in a range from about 800° C. to about 1200° C. Embodiments described herein may be particularly useful for molten material at temperatures equal to or greater than 1400° C., such as equal to or greater than about 1500° C., for example in a range from about 800° C. to about 1600° C., although in further embodiments, a temperature of the molten material may be less than 800° C., or even greater than 1600° C.

The refractory coating layer may, for example, include SiO₂ in an amount from about 45 wt % to about 90 wt %, Al₂O₃ in an amount from about 3 wt % to about 48 wt %, B₂O₃ in an amount from about 4 wt % to about 8 wt %, and CaO in an amount from about 1.6 wt % to about 5 wt %. In some embodiments, the refractory coating layer may include Al₂O₃ whiskers distributed in a SiO₂ matrix.

The refractory coating layer may include, on an oxide basis, SiO₂ in an amount from about 76 wt % to about 90 wt %, Al₂O₃ in an amount from about 3 wt % to about 11 wt %, B₂O₃ in an amount from about 4 wt % to about 8 wt %, and CaO in an amount from about 1.6 wt % to about 5 wt %. In further embodiments, the refractory coating layer may include SiO₂ in an amount from about 45 wt % to about 58 wt %, Al₂O₃ in an amount from about 35 wt % to about 48 wt %, B₂O₃ in an amount from about 4 wt % to about 4.5 wt %, and CaO in an amount from about 3 wt % to about 3.6 wt %.

The refractory coating layer may have a thickness of about 10 μm to about 500 μm, for example in a range from about 10 μm to about 450 μm, in a range from about 10 mm to about 400 μm, in a range from about 10 μm to about 350 μm, or in a range from about 10 μm to about 300 μm, including all ranges and subranges therebetween. The refractory grains may include ZrO₂ (zirconia), and grain boundaries between the refractory grains may be at least partially filled with glass such as SiO₂. In some embodiments, the refractory body may comprise a fused cast refractory.

According to another embodiments of the disclosure, a refractory coating composition is disclosed, including a first refractory material including, on an oxide basis, SiO₂ in an amount from about 55 wt % to about 70 wt %, Al₂O₃ in an amount from about 12 wt % to about 22 wt %, B₂O₃ in an amount from about 5 wt % to about 15 wt %, and calcium oxide in an amount from about 5 wt % to about 10 wt %; and a second refractory material containing silica as a main component, wherein an amount of the second refractory material is about 45 parts by weight to about 400 parts by weight with respect to the first refractory material in an amount of 100 parts by weight.

The second refractory material may contain silica in an amount from about 94 wt % to about 98 wt %, and boron oxide (B₂O₃) in an amount from about 2 wt % to about 6 wt %. An amount of the second refractory material may be from about 45 parts by weight to about 75 parts by weight with respect to the first refractory material in an amount of 100 parts by weight. The refractory coating composition may further include a third refractory material comprising Al₂O₃, the third refractory material being in an amount from about 75 parts by weight to about 100 parts by weight with respect to the first refractory material in an amount of 100 parts by weight.

The first refractory material and the second refractory material may be dispersed in a dispersion medium as powder.

According to embodiments of the disclosure, a method of fabricating a refractory article is disclosed, the method including forming a slurry coating layer on a refractory body, the slurry coating layer including, on an oxide basis, SiO₂ in an amount from about 45 wt % to about 90 wt %, Al₂O₃ in an amount from about 3 wt % to about 48 wt %, B₂O₃ in an amount from about 4 wt % to about 8 wt %, and CaO in an amount from about 1.6 wt % to about 5 wt % based on a weight of the slurry coating layer excluding a dispersant. After the slurry coating layer is formed, the slurry coating layer may be heat treated, thereby forming the refractory article. In some embodiments, the refractory article may be, for example, a melting vessel, or any portion thereof, used in the manufacture of glass, for example in the manufacture of glass sheets. In some embodiments, the refractory article may be a conduit, or any portion thereof, configured to convey molten glass in a glass manufacturing process. In some embodiments, the refractory article may be a molding apparatus. In some embodiments, the refractory article may be a refractory brick, or any article formed by one or more refractory bricks, although in further embodiments, the refractory article may be any refractory article that may be exposed to a molten material, such as molten glass, at high temperature, for example and not limitation, a temperature equal to or greater than about 800° C., equal to or greater than 900° C., equal to or greater than about 1000° C., equal to or greater than about 1200° C., for example in a range from about 800° C. to about 1200° C. Embodiments described herein may be particularly useful for molten material at temperatures equal to or greater than 1400° C., such as equal to or greater than about 1500° C., for example in a range from about 800° C. to about 1600° C., although in further embodiments, a temperature of the molten material may be less than 800° C., or even greater than 1600° C.

The heat treating may be performed at a temperature in a range from about 1400° C. to about 1600° C. for a time in a range from about 30 hours to about 100 hours.

In some embodiments, the refractory body may comprise fused cast zirconia.

In some embodiments, the slurry coating layer may comprise, on an oxide basis, SiO₂ in an amount from about 76 wt % to about 90 wt %, Al₂O₃ in an amount from about 3 wt % to about 11 wt %, B₂O₃ in an amount from about 4 wt % to about 8 wt %, and CaO in an amount from about 1.6 wt % to about 5 wt % based on a weight of the slurry coating layer excluding a dispersant. After the heat treating, a micro-structure resulting from the slurry coating layer may include glass.

In some embodiments, the slurry coating layer may comprise, on an oxide basis, SiO₂ in an amount from about 45 wt % to about 58 wt %, Al₂O₃ in an amount from about 35 wt % to about 48 wt %, B₂O₃ in an amount from about 4 wt % to about 4.5 wt %, and CaO in an amount from about 3 wt % to about 3.6 wt % based on a weight of the slurry coating layer excluding a dispersant. After the heat treating, a micro-structure resulting from the slurry coating layer may include mullite crystals dispersed in a glass matrix.

In embodiments of the disclosure, a glass making apparatus is disclosed, the glass making apparatus comprising a melting vessel and a clarifying vessel in fluid communication with the melting vessel, and wherein at least one of the melting vessel and the clarifying vessel comprises an inner refractory wall, the inner refractory wall comprising a refractory coating layer on a surface thereof, the refractory coating layer comprising, on an oxide basis, SiO₂, Al₂O₃, B₂O₃, and CaO. In some embodiments, the refractory coating layer may comprise SiO₂ in an amount from about 45 wt % to about 90 wt %, Al₂O₃ in an amount from about 3 wt % to about 48 wt %, B₂O₃ in an amount from about 4 wt % to about 8 wt %, and CaO in an amount from about 1.6 wt % to about 5 wt %. For example, in some embodiments, the refractory coating layer may comprises SiO₂ in an amount from about 76 wt % to about 90 wt %, Al₂O₃ in an amount from about 3 wt % to about 11 wt %, B₂O₃ in an amount from about 4 wt % to about 8 wt %, and CaO in an amount from about 1.6 wt % to about 5 wt %. In other embodiments, the refractory coating layer may comprise SiO₂ in an amount from about 45 wt % to about 58 wt %, Al₂O₃ in an amount from about 35 wt % to about 48 wt %, B₂O₃ in an amount from about 4 wt % to about 4.5 wt %, and CaO in an amount from about 3 wt % to about 3.6 wt %.

The refractory coating layer may comprise alumina whiskers distributed in a SiO₂ matrix.

In some embodiments, a thickness of the refractory coating layer may be in a range from about 10 μm to about 500 μm, for example in a range from about 10 μm to about 450 μm, in a range from about 10 mm to about 400 μm, in a range from about 10 μm to about 350 μm, or in a range from about 10 μm to about 300 μm, including all ranges and subranges therebetween.

In some embodiments, the inner wall includes refractory grains with grain boundaries therebetween, the refractory grains comprise ZrO₂, and the grain boundaries between the refractory grains are at least partially filled with SiO₂.

In some embodiments, the inner wall comprises a fused cast refractory, for example, fused cast zirconia.

It is to be understood that both the foregoing general description and the following detailed description present embodiments intended to provide an overview or framework for understanding the nature and character of the disclosure. The accompanying drawings are included to provide further understanding, and are incorporated into and constitute a part of this disclosure. The drawings illustrate various embodiments of the disclosure, and together with the description, serve to explain the principles and operations thereof.

### DESCRIPTION OF THE DRAWINGS

FIG. 1 schematically illustrates a refractory body in partial cross section according to embodiments disclosed herein;

FIG. 2 is a cross-sectional view schematically showing a microstructure of a refractory body according to embodiments;

FIG. 3 is a process flow diagram showing an exemplary glass sheet manufacturing apparatus, to which a refractory article according to embodiments disclosed herein may be applied;

FIGS. 4A and 4B are schematic diagrams showing potential causes of a defect increase during an initial stage of operation;

FIGS. 5A and 5B are images showing results of crack tests in an Experiment Example 1 and a Comparative Example 1;

FIGS. 6A and 6B are images showing cross-sections of refractory coating layers in refractory articles of an Experiment Example 1 and an Experiment Example 7; and

FIG. 7 is a flowchart of a method of manufacturing a refractory article, according to an embodiment.

### DETAILED DESCRIPTION

Embodiments of the disclosure will now be described more fully with reference to the accompanying drawings, in which exemplary embodiments of the disclosure are shown. The disclosure may, however, be embodied in many different forms and should not be construed as being limited to the exemplary embodiments set forth herein; rather, these embodiments are provided so that this disclosure will be thorough and complete, and will fully convey the concept of the disclosure to those skilled in the art. In the drawings, the thicknesses of layers and regions may be exaggerated for clarity. Like reference numerals in the drawings denote like elements. Therefore, the disclosure is not limited to relative sizes or intervals in the accompanied drawings.

While such terms as “first,” “second,” etc., may be used to describe various components, such components must not be limited to the above terms. The above terms are used only to distinguish one component from another. For example, a first component may indicate a second component or a second component may indicate a first component without conflicting with the disclosure.

The terms used herein in various exemplary embodiments of the disclosure are to describe embodiments only, and should not be construed to limit the various exemplary embodiments of the disclosure. Singular expressions, unless defined otherwise in contexts, include plural expressions. The terms “comprises” or “may comprise” used herein in various exemplary embodiments of the disclosure may indicate the presence of a corresponding function, operation, or component and does not limit one or more additional functions, operations, or components. It will be further understood that the terms “comprises” and/or “comprising,” or variants thereof, when used in this specification, specify the presence of stated features, integers, steps, operations, elements, and/or components, but do not preclude the presence or addition of one or more other features, integers, steps, operations, elements, components, and/or groups thereof.

When a certain embodiment may be implemented differently, a specific process order may be performed differently from the described order. For example, two consecutively described processes may be performed substantially at the same time or performed in an order opposite to the described order.

Variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. As used herein, the term “and/or” includes any and all combinations of one or more of the associated listed items.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as may be used herein—for example up, down, right, left, front, back, top, bottom—are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, unless otherwise stated, the terms “batch” and “raw material” are synonymous and used interchangeably. As used herein, unless otherwise stated, the terms “molten material” and “melt” are synonymous and may be used interchangeably.

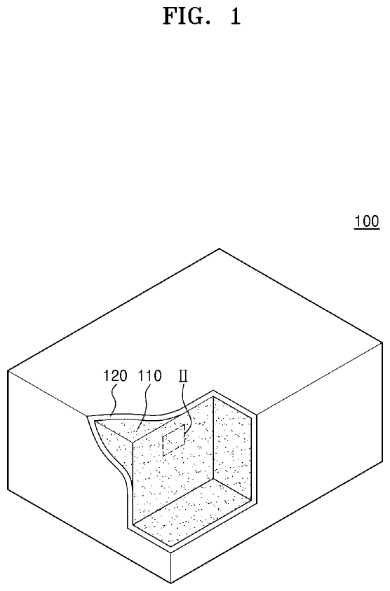

FIG. 1 is a partial cross-sectional schematic diagram of an exemplary refractory article 100 comprising a refractory body 110 and a refractory coating layer 120 coated on a surface of the refractory body. Although the refractory body 110 in FIG. 1 has an outer appearance of a rectangular parallelepiped, the refractory body 110 is not limited thereto, and may have various other shapes.

The refractory article 100 may be used to protect, contain, convey or otherwise contact a certain material or a structure under an environment of high temperature. In particular, the refractory article may be used to protect, contain, convey or otherwise contact a high temperature fluid, such as a molten material (e.g., molten glass), or a high temperature powder.

The refractory body 110 of the refractory article 100 may include, for example, zirconia (ZrO₂). In particular, the refractory body 110 may comprise zirconia as a main component of the refractory body. As used herein, “main component” is defined as a component having a component ratio exceeding 50 percent by weight (wt %) of the refractory body. For example, that the main component of the refractory body 110 is zirconia denotes that an amount of the zirconia comprising the refractory body 110 exceeds 50 wt %.

In some embodiments, the refractory body 110 may comprise a fused cast refractory material. The fused cast refractory material may have a dense structure, in which pores are rarely formed, but is not limited thereto. Accordingly, in further embodiments the refractory body 110 may be a porous refractory body.

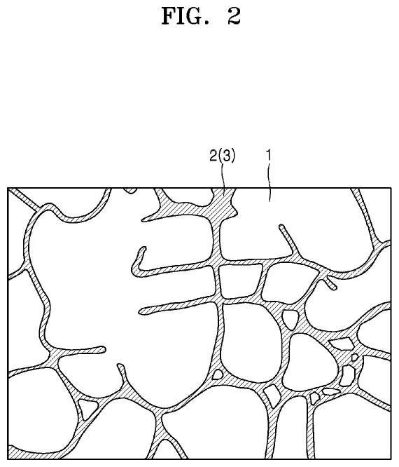

When the refractory body 110 comprises a fused cast refractory material, the refractory body 110 may include a plurality of grains including zirconia, wherein the plurality of grains are densified. FIG. 2 is a schematic cross-sectional view of a microstructure of the refractory body 110 according to embodiments, wherein the microstructure may correspond to a portion II in FIG. 1.

Referring to FIG. 2, zirconia grains 1 are densified with grain boundaries 2 interposed therebetween. The grain boundaries 2 may partially include a void, but may be filled with a heterogeneous material 3. In some embodiments, the grain boundaries 2 between the zirconia grains 1 may be at least partially filled with the heterogeneous material 3 such as SiO₂ or ZrSiO₄.

Referring back to FIG. 1, the refractory coating layer 120 may comprise any one or more of silica, alumina, boron oxide, and calcium oxide. The refractory coating layer 120 may comprise, for example, silica (SiO₂) in an amount from about 45 wt % to about 90 wt %, alumina (Al₂O₃) in an amount from about 3 wt % to about 48 wt %, boron oxide (B₂O₃) in an amount from about 4 wt % to about 8 wt %, and calcium oxide (CaO) in an amount from about 1.6 wt % to about 5 wt %.

If the amount of silica is too high, the refractory coating layer 120 may not be evenly formed over the refractory body 110. Conversely, if the amount of silica is too low, the amount of alumina becomes relatively high, and the refractory coating layer 120 may be easily lost from refractory body 110. When the refractory coating layer 120 is lost from the refractory body 110, particles shed from the coating layer and/or the refractory body may survive in the glass melt, and may subsequently cause a defect in a product produced therefrom. In particular, alumina typically has a lower solubility in the glass melt than silica, and thus, when the amount of alumina increases, the incidence of defective products may increase.

In some embodiments, the refractory coating layer 120 may further include a network modifier such as strontium oxide (SrO).

When the refractory body 110 is coated by the refractory coating layer 120 having one of the foregoing compositions, shedding of particles from the refractory body 110, whereby inclusions (typically referred to as “stones”) may be included in the melt, may be effectively reduced or even prevented. For example, when the refractory article 100 is used in a process for manufacturing glass products, the introduction of stones originating from the refractory body 110 into the glass melt, and subsequent glass products formed from the melt, may be reduced.

In some embodiments, the refractory coating layer 120 may include SiO₂ in an amount from about 76 wt % to about 90 wt %, Al₂O₃ in an amount from about 3 wt % to about 11 wt %, B₂O₃ in an amount from about 4 wt % to about 8 wt %, and CaO in an amount from about 1.6 wt % to about 5 wt %. In this case, the refractory coating layer 120 may have an amorphous microstructure, for example amorphous glass.

In some embodiments, the refractory coating layer 120 may include SiO₂ in an amount from about 45 wt % to about 58 wt %, Al₂O₃ in an amount from about 35 wt % to about 48 wt %, B₂O₃ in an amount from about 4 wt % to about 4.5 wt %, and CaO in an amount from about 3 wt % to about 3.6 wt %. In this case, the refractory coating layer 120 may have a microstructure in which whiskers are distributed in a glass matrix. As used herein, “whisker” denotes an elongated shape that may be straight, or may comprise some curvatures. For example, a whisker may have a needle shape, a rod shape, or a pillar shape, but the whisker shape is not limited thereto. The whiskers may be evenly distributed in the glass matrix, or may be generally evenly distributed in some regions and locally concentrated in other regions.

The refractory coating layer 120 may have a thickness of about 10 micrometers (μm) to about 500 μm, for example in a range from about 10 μm to about 450 μm, in a range from about 10 mm to about 400 μm, in a range from about 10 μm to about 350 μm, or in a range from about 10 μm to about 300 μm, including all ranges and subranges therebetween. If the refractory coating layer 120 is too thin, crack resistance of the refractory body may be lowered. On the other hand, if the refractory coating layer 120 is too thick, it may be uneconomical.

The refractory article described above may be used in various high temperature processes. For example, the refractory article may be applied to the manufacturing of glass products, such as glass sheet, by any one of a variety of manufacturing processes, including, by way of example and not limitation, float glass manufacturing processes, up draw glass manufacturing processes, down draw glass manufacturing processes (including, for example, fusion down draw glass manufacturing processes, rolling glass manufacturing processes, or any other glass manufacturing processes that utilize one or more refractory articles for contacting molten glass. For example, the refractory article may be any one or more of a melting vessel wherein raw materials are melted to form the glass melt, a clarifying vessel for removing bubbles from the glass melt or a conduit for conveying molten glass.

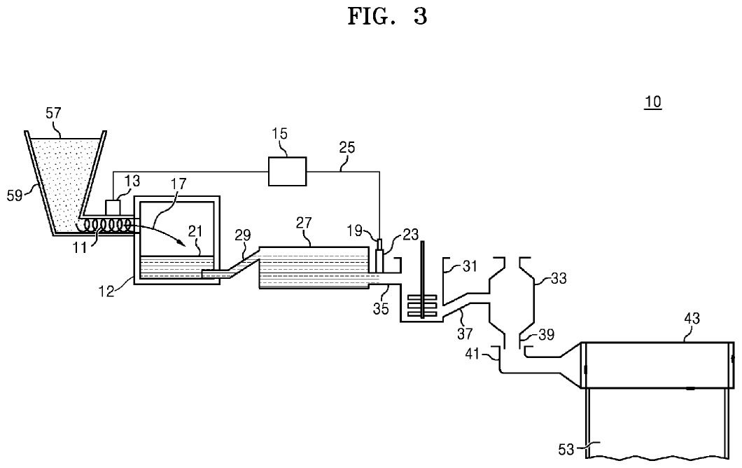

FIG. 3 is an elevational view of an exemplary fusion down draw glass sheet manufacturing apparatus 10, to which the refractory article according to embodiments of the disclosure may be applied. The glass sheet manufacturing apparatus 10 may include a melting vessel 12 configured to receive raw material 37 (batch) supplied from a storage bin 59. Melting vessel 12 is typically formed from a refractory material, such as a refractory ceramic material, for example a refractory ceramic material comprising alumina or zirconia. In some examples, melting vessel 12 may be constructed from refractory ceramic bricks. The batch material 57 may be introduced into the melting vessel 12 by a batch conveying device 11 that is driven by a motor 13. A controller 15 may control the motor 13 so that a desired amount of the batch material 57 may be introduced into the melting vessel 12, as denoted by the arrow 17. A glass level probe 19 may be used to measure a level of glass melt 21 in a stand pipe 23, and may communicate with the controller 15 to send measured level information via a communication line 25 to the controller.

The glass sheet manufacturing apparatus 10 may include a clarifying vessel 27, e.g., a clarifying tube, which may be located downstream of the melting vessel 12 relative to a flow direction of the molten glass, wherein the clarifying vessel 27 fluidly communicates with the melting vessel 12 via a first connection tube 29. In addition, a mixing vessel 31, e.g., an agitating chamber, may be located downstream of the clarifying vessel 27, and a transfer vessel 33, may be located downstream of the mixing vessel 31. As shown in FIG. 3, a second connection tube 35 may connect the clarifying vessel 27 to the mixing vessel 31, and a third connection tube 37 may connect the mixing vessel 31 to the transfer vessel 33. A downcomer 39 may be located to transfer the glass melt 21 from the transfer vessel 33 to an inlet tube 41 of a molding apparatus 43.

At least a portion of the melting vessel 12, for example, at least a portion of an inner wall of the melting vessel, may include a refractory article as described above. For example, the refractory article may include one or more refractory bricks of the melting vessel. In some embodiments, the refractory article may include at least a portion, or an entirety, of an inner wall of the melting vessel 12, wherein the inner wall is configured to retain the molten glass. Accordingly, at least a portion of the inner wall may be coated with the refractory coating. The glass sheet manufacturing apparatus 10 may further include metallic components that generally include platinum or platinum-containing metal, for example, platinum-rhodium, platinum-iridium, and/or a combination thereof, but the components may also include molybdenum, palladium, rhenium, tantalum, titanium, tungsten, ruthenium, osmium, zirconium, and alloys thereof, and/or refractory metals such as zirconium dioxide. The platinum-containing components may include at least one of the first connection tube, the clarifying vessel 27 (e.g., the clarifying tube), the second connection tube 35, the stand pipe 23, the mixing vessel 31 (e.g., the agitating chamber), the third connection tube 37, the transfer vessel 33, the downcomer 39, and the inlet tube 41. In some embodiments, however, any one or more of the foregoing components may be refractory components containing the refractory article described above. In some embodiments, at least a part of the molding apparatus 43 may include the refractory article as described above, and may be designed to form a glass sheet 53. For example, in some embodiments, the molding apparatus 43 may be a homogeneous refractory (e.g., ceramic) block, that comprises the refractory article, although in further embodiments, the molding apparatus may comprise a plurality of individual blocks joined to form at least a portion of, and in some instances a complete molding apparatus. Accordingly, at least a portion of the molding apparatus may be coated with a refractory coating layer as described herein. In some embodiments, the refractory article may comprise the clarifying vessel, wherein the clarifying vessel comprises a refractory inner wall, wherein at least a portion of the inner wall of the clarifying vessel is coated with a refractory coating layer as described herein.

It has been found that the number of defective products produced by the glass manufacturing apparatus 10 may increase during an initial stage of operating the glass sheet manufacturing apparatus right after start-up thereof (e.g., within six months after the start-up). While not wishing to be held to theory, the increase in product defects has been thought to be due to particles being shed from the refractory of the melting vessel 12 or the molding apparatus 43. That is, during a process of raising the temperature for operating the glass sheet manufacturing apparatus 10 (heat-up), cracks may generate and propagate in the refractory article or articles. Then, when the glass sheet manufacturing apparatus 10 starts to operate under steady state conditions, zirconia particles that are lost from the propagated crack may be mixed into the glass melt and may cause defects in subsequent products formed from the glass melt.

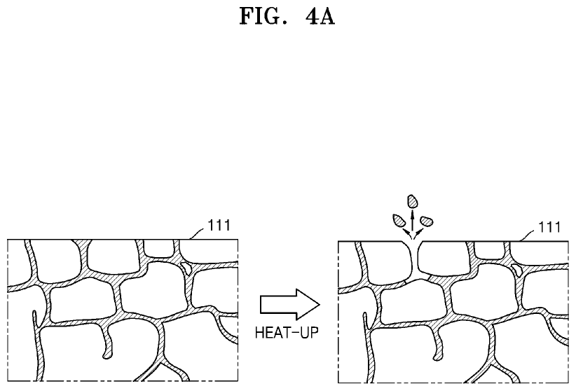

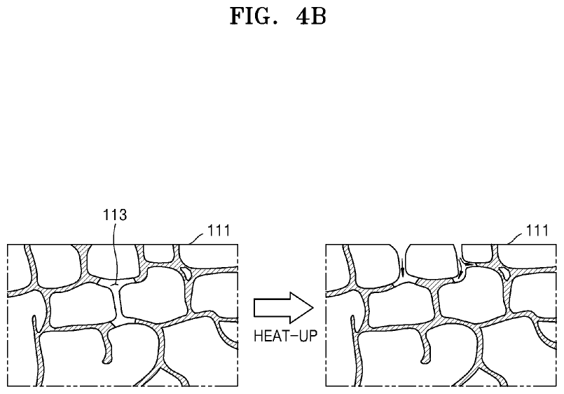

There may be various causes of crack formation in the refractory article, and FIGS. 4A and 4B are schematic diagrams showing potential causes of defects that may appear during an initial stage of operation. Referring to FIGS. 4A and 4B in more detail, a binding component (e.g., silica) in the grain boundary 2 adjacent to a surface 111 of the refractory article may experience a decrease in viscosity (e.g., become fluid) during the heat-up process and may be at least partially exuded from the grain boundary (see FIG. 4A). In other instances, the binding component adjacent to the surface 111 may be pulled into the refractory article due to capillary action generated within a pore 113 existing in the grain boundary, and thus at least a portion of the refractory article adjacent to the surface 111 may be weakened (see FIG. 4B).

Therefore, when exudation of the binding component in the grain boundaries is prevented by providing a coating layer on the surface 111 of the refractory article, surface cracking caused by the exudation as shown in FIG. 4A may be reduced or prevented. In addition, even if the binding component adjacent to the surface 111 is pulled into the refractory article, the coating layer may fill the resultant void, thereby preventing generation of a surface crack. Moreover, even if the coating layer is partially lost, if that the lost portion of the coating layer is easily dissolved in the glass melt under operating conditions, and compatible therewith, product defects may be further reduced.

Hereinafter, features and effects will be described in more detail with reference to both experimental and comparative examples, with the understanding that the scope of the disclosure is not limited to the experimental examples.

### Experimental Example 1

A first refractory material including SiO₂ in an amount of 63 wt %, Al₂O₃ in an amount of 17 wt %, B₂O₃ in an amount of 10 wt %, CaO in an amount of 8 wt %, and SrO in an amount of 2 wt % was prepared. In addition, a second refractory material including SiO₂ in an amount of 96 wt % and B₂O₃ in an amount of 4 wt % was prepared.

The first refractory material and the second refractory material were mixed in a weight ratio of 1:1, and deionized (DI) water was added to the mixture and pulverized by ball milling to fabricate a refractory coating slurry. Methyl cellulose was added in an amount of 2% of an entire weight of the mixture to adjust the viscosity of the mixture.

The refractory coating slurry as prepared above was spray-coated on a first refractory body including fused cast zirconia. The refractory coating slurry in a slurry supply tank was continuously agitated using compressed air to maintain homogeneity of the refractory coating slurry during the spray coating process. The thickness of the refractory coating slurry that was formed on the refractory body was adjusted to have a thickness of about 100 μm after being dried.

After that, the slurry-coated refractory body was placed in a furnace and a temperature of the furnace was raised to 1550° C. at a heating rate of 9° C. per hour, after which the furnace temperature was maintained at 1550° C. for 72 hours to obtain a refractory article for heat treatment.

A crack test was performed on the obtained refractory article by placing the refractory article in the furnace at 1550° C. for another 72 hours. The refractory article was slowly cooled down to room temperature and was examined for cracking.

### Comparative Example 1

A crack test was performed on a second refractory body including fused cast zirconia, wherein the second refractory body was not coated by the previously prepared refractory coating slurry, by placing the second refractory body in a furnace, heating the furnace to a temperature of 1550° C. at a rate of 9° C. per hour, and holding the furnace temperature at 1550° C. for 72 hours. Then the second refractory body was slowly cooled down to room temperature and was examined for cracking after the foregoing heat treatment.

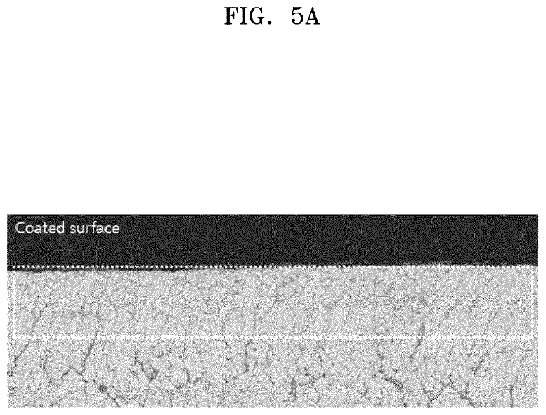

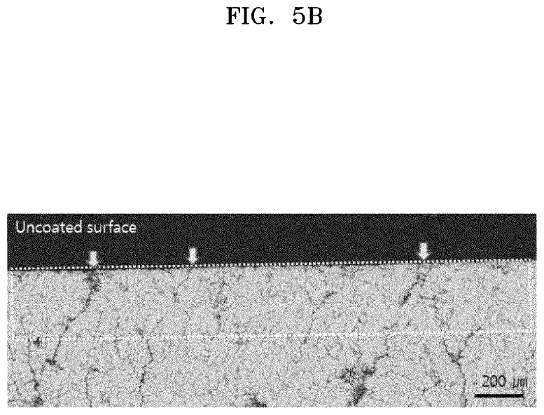

FIGS. 5A and 5B are images showing results of the crack tests according to the Experimental Example 1 and the Comparative Example 1, respectively.

Referring to FIG. 5A, it may be seen that cracking of the refractory body did not occur in a surface thereof under the refractory coating layer. In addition, it may be further seen that silica between grain boundaries adjacent to the surface was not exuded or lost.

However, referring to FIG. 5B, cracking occurred in a surface of the refractory body, which was not coated (see portions denoted by arrows).

### Experimental Examples 2 to 5

A refractory article was fabricated in the same way as the Experimental Example 1, except that a mixing ratio between the first refractory material and the second refractory material was changed as shown in Table 1 below.

### Comparative Example 2

A refractory article was fabricated in the same way as the Experimental Example 1, except that a mixing ratio between the first refractory material and the second refractory material was changed as shown in Table 1 below.

### Experimental Examples 6 and 7

A refractory article was fabricated in the same way as the Experimental Example 1, except that silica was used as the second refractory material, alumina was used as a third refractory material, and a mixing ratio among the first refractory material, the second refractory material, and the third refractory material was changed as shown in Table 1 below.

### Comparative Examples 3 to 6

A refractory article was fabricated in the same way as the Experimental Example 1, except that silica was used as the second refractory material, alumina was used as a third refractory material, and a mixing ratio among the first refractory material, the second refractory material, and the third refractory material was changed as shown in Table 1 below.

The mixing ratios among the refractory materials used to fabricate the refractory according to the Experimental Examples 1 to 7 and the Comparative Examples 2 to 6, and compositions of the refractory coating layers obtained from the refractory materials are shown in Table 1 below.

TABLE 1

| | D1 | D2 | D3 | SiO₂ | Al₂O₃ | B₂O₃ | CaO |
|---|---|---|---|---|---|---|---|
| Experimental | 50 | 50 | 0 | 79.5 | 8.5 | 7.0 | 4.0 |
| Example 1 | | | | | | | |
| Experimental | 33.3 | 66.7 | 0 | 85.0 | 5.7 | 6.0 | 2.7 |
| Example 2 | | | | | | | |
| Experimental | 60 | 40 | 0 | 76.2 | 10.2 | 7.6 | 4.8 |
| Example 3 | | | | | | | |
| Experimental | 20 | 80 | 0 | 89.4 | 3.4 | 5.2 | 1.6 |
| Example 4 | | | | | | | |
| Experimental | 66 | 34 | 0 | 74.2 | 11.2 | 8.0 | 5.3 |
| Example 5 | | | | | | | |
| Experimental | 40 | 35 | 25 | 60.2 | 31.8 | 4.0 | 3.2 |
| Example 6 | | | | | | | |
| Experimental | 43 | 26 | 31 | 53.1 | 38.3 | 4.3 | 3.4 |
| Example 7 | | | | | | | |
| Comparative | 15 | 85 | 0 | 91.1 | 2.6 | 4.9 | 1.2 |
| Example 2 | | | | | | | |
| Comparative | 20 | 35 | 45 | 47.6 | 48.4 | 2.0 | 1.6 |
| Example 3 | | | | | | | |
| Comparative | 38 | 20 | 42 | 43.9 | 48.5 | 3.8 | 3.0 |
| Example 4 | | | | | | | |
| Comparative | 40 | 15 | 45 | 40.2 | 51.8 | 4.0 | 3.2 |
| Example 5 | | | | | | | |
| Comparative | 39 | 20 | 41 | 44.6 | 47.6 | 3.9 | 3.1 |
| Example 6 | | | | | | | |

In Table 1 above, D1 denotes the first refractory material, D2 denotes the second refractory material, and D3 denotes the third refractory material as a percent of the total mixture of the first, the second, and the third refractory materials. All refractory material constituents in Table 1 are shown in wt %.

Surface uniformity, flow down characteristic, droplet characteristic, and delamination characteristic were examined on the refractories articles manufactured according to the experimental examples 1 to 7 and the comparative examples 2 to 6.

Surface uniformity was evaluated by measuring surface undulation of the refractory coating layer. When the surface undulation exceeded 500 μm, the surface uniformity was evaluated as X, when the surface undulation exceeded 300 μm and was equal to or less than 500 μm, the surface uniformity was evaluated as Δ, when the surface undulation exceeded 100 μm and was equal to or less than 300 μm, the surface uniformity was evaluated as ◯, and when the surface undulation was equal to or less than 100 μm, the surface uniformity was evaluated as ⊚.

The flow down characteristic was evaluated by observing whether a feature related to a flow of the refractory coating layer was found on a side surface of the refractory article. If the refractory coating layer had a flat surface and a constant thickness on the side surface of the refractory article, the flow down characteristic was evaluated as ⊚, if the refractory coating layer had a relatively flat surface but had a portion having an increased thickness downward, the flow down characteristic was evaluated as ◯, if the refractory coating layer had an uneven surface, the flow down characteristic was evaluated as Δ, and if a pattern of flow prominently remained on the refractory coating layer, the flow down characteristic was evaluated as X.

The droplet characteristic was evaluated by observing whether droplets or wetting that is a preliminary phenomenon of the droplet formation is generated on the refractory article surface. If there was no droplet and the surface was flat, the droplet characteristic was evaluated as ⊚, if some of the surface was not wet, the droplet characteristic was evaluated as ◯, if there were droplets even on a part of the refractory coating layer, the droplet characteristic was evaluated as Δ, and if the droplets were present throughout a significant area of the refractory coating layer, the droplet characteristic was evaluated as X.

The delamination characteristic was evaluated by observing surface cracking and delamination of the refractory coating layer right after the heat treating. If there was a portion of the refractory coating layer that was peeled off and lost from the surface of the refractory body to expose the refractory body, the isolation characteristic was evaluated as X, if a small portion of the refractory coating layer that was partially peeled off, although not lost to expose the refractory body, the isolation characteristic was evaluated as Δ, if the surface of the refractory coating layer was smooth except that fine cracks had formed in at least a portion of the refractory coating layer, the isolation characteristic was evaluated as ◯, and if the refractory coating layer had a smooth surface and no cracking was found, the isolation characteristic was evaluated as ⊚.

The surface uniformity, the flow down characteristic, the droplet characteristic, and the isolation characteristic examined with respect to the Experimental Examples 1 to 7 and the Comparative Examples 2 to 6 are shown in Table 2 below.

TABLE 2

| | Surface | | | |
|---|---|---|---|---|
| | uniformity | Flow down | Droplet | Delamination |
| Experimental | ⊚ | ⊚ | ⊚ | ⊚ |
| Example 1 | | | | |
| Experimental | ⊚ | ⊚ | ⊚ | ⊚ |
| Example 2 | | | | |
| Experimental | ⊚ | ⊚ | ⊚ | ⊚ |
| Example 3 | | | | |
| Experimental | ⊚ | ⊚ | ⊚ | ⊚ |
| Example 4 | | | | |
| Experimental | ⊚ | ⊚ | ◯ | ⊚ |
| Example 5 | | | | |
| Experimental | ⊚ | ◯ | ⊚ | ⊚ |
| Example 6 | | | | |
| Experimental | ⊚ | ⊚ | ⊚ | ⊚ |
| Example 7 | | | | |
| Comparative | X | ◯ | ◯ | ⊚ |
| Example 2 | | | | |
| Comparative | ◯ | Δ | Δ | Δ |
| Example 3 | | | | |
| Comparative | X | Δ | Δ | Δ |
| Example 4 | | | | |
| Comparative | Δ | X | Δ | X |
| Example 5 | | | | |
| Comparative | X | X | X | ◯ |
| Example 6 | | | | |

As shown in Table 2 above, it was observed that the surface uniformity was defective when an amount of silica exceeded 90 wt % (Comparative Example 2). In addition, the flow down characteristic, the droplet characteristic, and the delamination characteristic are not sufficiently high when an amount of alumina exceeds 48 wt % (Comparative Example 3). When the amount of silica is less than 45 wt % and the amount of alumina exceeds 48 wt %, all of the evaluated characteristics are insufficient or bad (Comparative Examples 4 and 5). When the amount of silica is less than 45 wt % and the amount of alumina does not exceed 48 wt %, the surface uniformity, the flow down characteristic, and the droplet characteristic are all bad whereas the delamination characteristic is fair (Comparative Example 6).

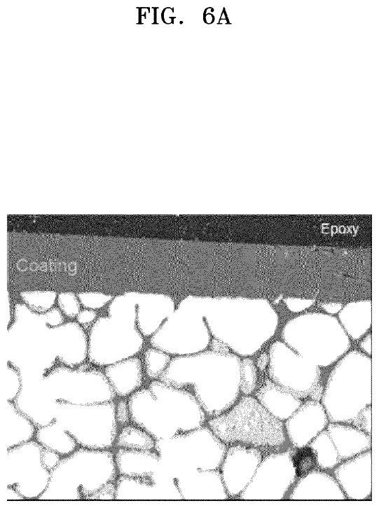

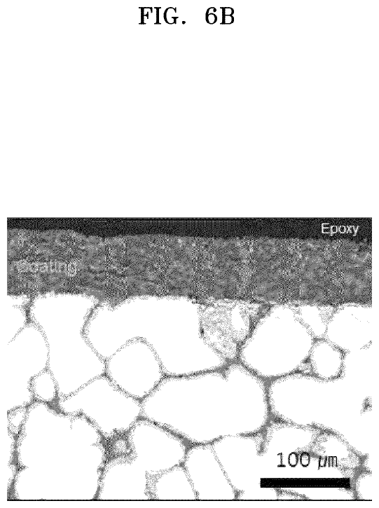

In addition, the refractory coating layers of the refractory articles obtained in the Experimental Examples 1 and 7 were analyzed by an energy dispersive X-ray spectroscopy (EDS), and cross-sectional images of the refractory coating layers obtained by the EDS are shown in FIGS. 6A and 6B. For the convenience of handling, the refractory articles obtained in the Experimental Examples 1 and 7 were first attached onto epoxy handling substrates and then the cross-sectional images were obtained.

As shown in FIG. 6A, in a case where the first refractory material and the second refractory material are only used without using the third refractory material, a refractory coating layer exhibits an amorphous glass phase. In addition, as shown in FIG. 6B, in a case where the third refractory material, i.e. alumina, is used, a microstructure in which mullite crystals are dispersed in a glass matrix is obtained. The mullite crystals can improve a mechanical and physical properties of the refractory articles by increasing the mechanical strength and thermal shock resistance.

Hereinafter, the refractory coating slurry described above will be described in more detail.

The refractory coating slurry may include the first refractory material and the second refractory material, wherein an amount of the second refractory material is from about 45 parts by weight to about 75 parts by weight with respect to the first refractory material in an amount of 100 parts by weight.

Here, the first refractory material may include, on an oxide basis, SiO₂ in an amount from about 55 wt % to about 70 wt %, Al₂O₃ in an amount from about 12 wt % to about 22 wt %, B₂O₃ in an amount from about 5 wt % to about 15 wt %, and CaO in an amount from about 5 wt % to about 10 wt %. In addition, the second refractory material may be a mixture containing SiO₂ as a main component. For example, the second refractory material may include SiO₂ in an amount from about 94 wt % to about 98 wt %, and B₂O₃ in an amount from about 2 wt % to about 6 wt %.

In some embodiments, the refractory coating slurry may include the second refractory material in an amount from about 45 parts by weight to about 75 parts by weight with respect to 100 parts by weight of the first refractory material. In some embodiments, the second refractory material may include SiO₂. In some embodiments, the second refractory material may consist of SiO₂.

If the amount of the second refractory material is excessively large with respect to an amount of the first refractory material, the refractory coating slurry may be unevenly coated. On the other hand, if the amount of the second refractory material is too small with respect to an amount of the first refractory material, droplets of the refractor coating slurry may be formed in a coating layer or a flow down effect may occur.

In some embodiments, the refractory coating slurry may further include the third refractory material. For example, an amount of the third refractory material may be from about 75 parts by weight to about 100 parts by weight with respect to 100 parts by weight of the first refractory material.

The third refractory material may include Al₂O₃. In some embodiments, the third refractory material may consist of Al₂O₃.

If the amount of the third refractory material is excessively large with respect to an amount of the first refractory material, a coating layer may be delaminated and lost after the heat treating. On the other hand, if the amount of the third refractory material is too small with respect to an amount of the first refractory material, an uneven coating layer may be formed.

The first, second, and third refractory materials may be dispersed in a dispersion medium as powder. The dispersion medium may be a hydrophilic liquid such as water, a C₁-C₅ alcohol-based solvent, a C₂-C₈ glycol-based solvent, etc. Such a liquid as above may be referred to as a “solvent”, but the above liquid actually disperses the first, second, and third refractory materials therein, without dissolving the first to third refractory materials, and thus, the liquid may be more aptly termed a “dispersion medium” (dispersant).

To avoid phase separation, the refractory coating slurry should be continuously homogenized, for example by agitation, in order to form a uniform coating layer.

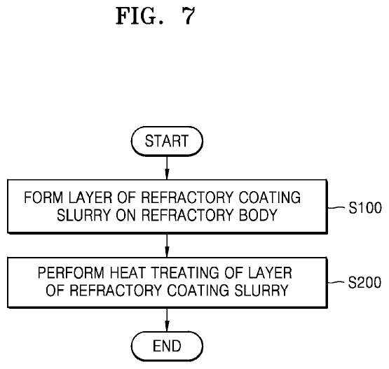

Hereinafter, a method of manufacturing the refractory article will be described. FIG. 7 is a flowchart of a method of manufacturing a refractory article according to various embodiments.

Referring to FIG. 7, In a first step S100, a layer of a refractory coating slurry is formed on a refractory body. The refractory coating slurry may include SiO₂ in an amount from about 45 wt % to about 90 wt %, Al₂O₃ in an amount of about 3 wt % to about 48 wt %, B₂O₃ in an amount of about 4 wt % to about 8 wt %, and CaO in an amount of about 1.6 wt % to about 5 wt % based on a weight thereof, excluding a dispersion medium. Since the refractory body and the refractory coating slurry are described above in detail, repeated descriptions thereof are omitted here.

The layer of refractory coating slurry on the refractory body may be formed by spraying, brushing, a doctor blade, or any other suitable method, and is not limited thereto.

The layer of the refractory coating slurry may be adjusted to have a thickness of about 10 μm to about 500 μm after a heat treatment step S200. To this end, the layer of refractory coating slurry before heat treatment step may be appropriately adjusted to have a thickness of about 15 μm to about 700 μm. If the layer of refractory coating slurry is too thin, resistance to surface cracking in the refractory body may be insufficient. On the other hand, if the layer is too thick, a portion of the refractory coating layer may fall off, which may result in an increase in defective products. One of ordinary skill in the art can appropriately select the thickness of the layer of the refractory coating slurry, taking the above factors into account.

Once the refractory coating slurry has been applied to the refractory body, the heat treatment step S200 of the layer of the refractory coating slurry may be performed. The heat treatment step may be performed at a temperature in a range from about 1400° C. to about 1600° C. for a duration in a range from about 30 hours to about 100 hours. If the heat treatment is performed at an excessively low temperature or for an excessively short period of time, the refractory coating layer may exhibit low strength and may be unable to prevent surface cracking of the refractory body. On the other hand, if the heat treatment is performed at an excessively high temperature or for an excessively long period of time, the refractory coating layer may be delaminated and defective products may increase. One of ordinary skill in the art can appropriately select the temperature and the duration of time for performing the heat treating, taking the above factors into account.

The layer of the refractory coating slurry may form an amorphous glass phase through the heat treating, or other microstructures, depending on a composition of the refractory coating slurry.

For example, when the refractory coating slurry has a composition, on an oxide basis, including SiO₂ in an amount from about 76 wt % to about 90 wt %, Al₂O₃ in an amount from about 3 wt % to about 11 wt %, B₂O₃ in an amount from about 4 wt % to about 8 wt %, and CaO in an amount from about 1.6 wt % to about 5 wt % based on a weight of the slurry coating layer, excluding a dispersion medium, an amorphous glass phase may be obtained after heat treatment.

In addition, when the refractory coating slurry has a composition including SiO₂ in an amount from about 45 wt % to about 58 wt %, Al₂O₃ in an amount from about 35 wt % to about 48 wt %, B₂O₃ in an amount from about 4 wt % to about 4.5 wt %, and CaO in an amount from about 3 wt % to about 3.6 wt % based on a weight of the slurry coating layer, excluding a dispersion medium, a microstructure in which mullite crystals are dispersed in a glass matrix may be obtained after heat treatment.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

1. A refractory article comprising:
a refractory body; and
a refractory coating layer on a surface of the refractory body, the refractory coating layer comprising, SiO₂, Al₂O₃, B₂O₃, and CaO.

2. The refractory article of claim 1, wherein the refractory coating layer comprises SiO₂ in an amount from about 45 wt % to about 90 wt %, Al₂O₃ in an amount from about 3 wt % to about 48 wt %, B₂O₃ in an amount from about 4 wt % to about 8 wt %, and CaO in an amount from about 1.6 wt % to about 5 wt %.

3. The refractory article of claim 2, wherein the refractory coating layer comprises alumina whiskers distributed in a SiO₂ matrix.

4. The refractory article of claim 2, wherein the refractory coating layer comprises SiO₂ in an amount from about 76 wt % to about 90 wt %, Al₂O₃ in an amount from about 3 wt % to about 11 wt %, B₂O₃ in an amount from about 4 wt % to about 8 wt %, and CaO in an amount from about 1.6 wt % to about 5 wt %.

5. The refractory article of claim 2, wherein the refractory coating layer comprises SiO₂ in an amount from about 45 wt % to about 58 wt %, Al₂O₃ in an amount from about 35 wt % to about 48 wt %, B₂O₃ in an amount from about 4 wt % to about 4.5 wt %, and CaO in an amount from about 3 wt % to about 3.6 wt %.

6. The refractory article of claim 1, wherein the refractory coating layer comprises a thickness of about 10 μm to about 500 μm.

7. The refractory article of claim 1, wherein the refractory body includes refractory grains with grain boundaries therebetween, the refractory grains comprise ZrO₂, and the grain boundaries between the refractory grains are at least partially filled with SiO₂.

8. The refractory of claim 7, wherein the refractory body is a fused cast refractory.

9. A refractory coating composition comprising:
a first refractory material comprising SiO₂ in an amount from about 55 wt % to about 70 wt %, Al₂O₃ in an amount from about 12 wt % to about 22 wt %, B₂O₃ in an amount from about 5 wt % to about 15 wt %, and CaO in an amount from about 5 wt % to about 10 wt %; and
a second refractory material containing SiO₂ as a main component,
wherein an amount of the second refractory material is about 45 parts by weight to about 400 parts by weight with respect to the first refractory material in an amount of 100 parts by weight.

10. The refractory coating composition of claim 9, wherein the second refractory material contains SiO₂ in an amount from about 94 wt % to about 98 wt %, and B₂O₃ in an amount from about 2 wt % to about 6 wt %.

11. The refractory coating composition of claim 9, wherein an amount of the second refractory material is from about 45 parts by weight to about 75 parts by weight with respect to the first refractory material in an amount of 100 parts by weight.

12. The refractory coating composition of claim 11, further comprising a third refractory material comprising Al₂O₃, the third refractory material being in an amount from about 75 parts by weight to about 100 parts by weight with respect to the first refractory material in an amount of 100 parts by weight.

13. A method of fabricating a refractory article, the method comprising:
forming a slurry coating layer on a refractory body, the slurry coating layer comprising, on an oxide basis, SiO₂ in an amount from about 45 wt % to about 90 wt %, Al₂O₃ in an amount from about 3 wt % to about 48 wt %, B₂O₃ in an amount from about 4 wt % to about 8 wt %, and CaO in an amount from about 1.6 wt % to about 5 wt % based on a weight of the slurry coating layer excluding a dispersant; and
heat treating the slurry coating layer, thereby forming the refractory article.

14. The method of claim 13, wherein the heat treating is performed at a temperature in a range from about 1400° C. to about 1600° C. for a time in a range from about 30 hours to about 100 hours.

15. The method of claim 13, wherein the refractory body comprises fused cast zirconia.

16. The method of claim 13, wherein the slurry coating layer comprises SiO₂ in an amount from about 76 wt % to about 90 wt %, Al₂O₃ in an amount from about 3 wt % to about 11 wt %, B₂O₃ in an amount from about 4 wt % to about 8 wt %, and CaO in an amount from about 1.6 wt % to about 5 wt % based on a weight of the slurry coating layer excluding a dispersant.

17. The method of claim 13, wherein the slurry coating layer comprises SiO₂ in an amount from about 45 wt % to about 58 wt %, Al₂O₃ in an amount from about 35 wt % to about 48 wt %, B₂O₃ in an amount from about 4 wt % to about 4.5 wt %, and CaO in an amount from about 3 wt % to about 3.6 wt % based on a weight of the slurry coating layer excluding a dispersant.

18. The method of claim 17, wherein, after the heat treating, a micro-structure resulting from the slurry coating layer includes mullite crystals dispersed in a SiO₂ matrix.

19. A glass making apparatus, comprising:
a melting vessel;
a clarifying vessel in fluid communication with the melting vessel; and
wherein at least one of the melting vessel and the clarifying vessel comprises an inside refractory wall, the inside refractory wall comprising a refractory coating layer on a surface thereof, the refractory coating layer comprising, on an oxide basis, SiO₂, Al₂O₃, B₂O₃, and CaO.

20. The glass making apparatus of claim 19, wherein the refractory coating layer comprises SiO₂ in an amount from about 45 wt % to about 90 wt %, Al₂O₃ in an amount from about 3 wt % to about 48 wt %, B₂O₃ in an amount from about 4 wt % to about 8 wt %, and CaO in an amount from about 1.6 wt % to about 5 wt %.
